(19) United States
(12) Patent Application Publication
(10) Pub. No.: US 2015/0050388 A1
(43) Pub. Date: Feb. 19, 2015

(54) SYNBIOTIC FOOD COMPOSITION CONTAINING TAGATOSE AND PROBIOTIC LACTIC ACID BACTERIA

(71) Applicant: CJ CHEILJEDANG CORPORATION, Seoul (KR)

(72) Inventors: Ji Hoon Koh, Seoul (KR); Young Jae Kim, Seoul (KR); Seung Won Park, Yongin-si (KR)

(21) Appl. No.: 14/389,578

(22) PCT Filed: Apr. 10, 2013
(86) PCT No.: PCT/KR2013/002982

§ 371 Date: Sep. 30, 2014

(30) Foreign Application Priority Data
Apr. 10, 2012 (KR) 10-2012-0037424

(51) Int. Cl. A23C 9/13

(52) U.S. Cl. CPC A23C 9/1307; A23Y 2220/17; A23Y 2220/73
USPC 426/61

(57) ABSTRACT

A synbiotic food composition is a food composition for promoting the active intestinal growth of Lactobacillus sp. lactic acid bacterium, containing lactic acid bacteria and tagatose as a source of nutrients for the bacteria strain. More particularly, The synbiotic food composition contains a Lactobacillus casei strain or Lactobacillus rhamnosus strain as a probiotic, and tagatose as a prebiotic.

### TECHNICAL FIELD

The present invention relates to a synbiotic food composition, which is a food composition for promoting the active intestinal growth of Lactobacillus sp. lactic acid bacterium, containing lactic acid bacteria and tagatose as a source of nutrients for the bacteria strain.

More particularly, the present invention relates to a synbiotic food composition containing a Lactobacillus casei strain or Lactobacillus rhamnosus strain as a probiotic, and tagatose as a prebiotic.

### BACKGROUND ART

The term “probiotics” means live microorganisms having a beneficial effect on the health of hosts such as humans, animals, or the like, or a component thereof, and it has been known that the probiotics provide a beneficial effect, for example, maintenance of a balance in intestinal microflora, to the host taking the probiotics.

Generally, the probiotics include beneficial bacteria such as lactic acid bacteria and Bifidobacteria and a range of yeasts. Among them, lactic acid bacteria belonging to the genera Lactobacillus, Lactococcus, Bifidobacteria, Streptococcus, and the like, have been mainly studied and used.

The lactic acid bacteria (LAB) have been used as generally recognized as safe (GRAS) to produce various fermented food for a long period of time. The lactic acid bacteria use various sugars including lactose as a substrate to convert the sugar into lactic acid, and suppress growth of harmful bacteria by imparting a sour taste to food and lowering a pH through the process as described above. Since the lactic acid bacteria have beneficial effects on humans in various aspects, for example, effects of controlling intestinal microflora of a host to suppress various intestinal diseases and promote immunity as well as an antibiotic effect, an interest in the development of the lactic acid bacteria as various food materials has been increased.

As described above, the lactic acid bacteria, which are representative probiotics, have been widely utilized in human life, for example, various fermented food, fermented soybeans, medicines, feed additive for livestock, and the like, as well as fermented milk products. Recently, researches emphasizing various health functional effects of lactic acid bacteria in the intestine of the host in addition to nutritional effects thereof have been conducted.

In order to increase in vivo activities of the lactic acid bacteria as described above, research into synbiotics obtained by mixing probiotics corresponding to live bacteria and prebiotics corresponding to a source of nutrients for the probiotics has been conducted. However, prebiotics used in the synbiotics according to the related art were significantly digested in the digestive organ of a host, such that the prebiotics did not efficiently act as the source of nutrients of the probiotics, and species specificity of the prebiotics is insufficient, such that the prebiotics were not efficient to increase an activity of a specific lactic acid bacterium.

Meanwhile, tagatose, which is an isomer of fructose, is a naturally produced low calorie natural sugar. Tagatose has a sweet taste similar to sugar, and a sweetness degree thereof is about 92% of sugar, but a calorie thereof is only about 38% of sugar and a glycemic index (GI) thereof is only about 4% of sugar, such that tagatose has been spotlighted as a sugar substitute sweetener.

In addition, a possibility that tagatose will be used as the prebiotics has been disclosed in Korean Patent No. 10-0620477, but there was almost no research into detailed application plans such as a range of the probiotics to which tagatose may be actually applied, and the like.

### DISCLOSURE

### Technical Problem

The present invention provides a food composition providing synbiotics containing tagatose as a prebiotic and a specific Lactobacillus sp. lactic acid bacterium specifically using tagatose as a probiotic to thereby assist in dominant proliferation of the specific lactic acid bacterium in the intestine of a host eating the food composition.

### Technical Solution

The present invention relates to a synbiotic food composition, which is a food composition for promoting active intestinal growth of Lactobacillus sp. lactic acid bacterium, containing lactic acid bacteria and tagatose as a source of nutrients for the bacteria strain.

According to an exemplary embodiment of the present invention, there is provided a food composition containing tagatose and Lactobacillus casei.

According to another exemplary embodiment of the present invention, the Lactobacillus casei may be one or more selected from a group consisting of Lactobacillus casei Shirota, Lactobacillus casei DN114001, and Lactobacillus casei-01®.

According to another exemplary embodiment of the present invention, based on 100 parts by weight of the composition,

the food composition may contain more than 0 to 20 parts by weight of tagatose; and more than 0 to 1 part by weight of Lactobacillus casei.

According to another exemplary embodiment of the present invention, there is provided a fermented milk composition containing: based on 100 parts by weight of the entire composition,

more than 0 to 20 parts by weight of tagatose;

more than 0 to 1 part by weight of Lactobacillus casei;

more than 0 to 10 parts by weight of skim milk powder; and

50 to 99 parts by weight of purified water.

According to another exemplary embodiment of the present invention, there is provided a food composition containing tagatose and Lactobacillus rhamnosus.

According to another exemplary embodiment of the present invention, the Lactobacillus rhamnosus may be Lactobacillus rhamnosus GG.

According to another exemplary embodiment of the present invention, based on 100 parts by weight of the composition,

the food composition may contain more than 0 to 20 parts by weight of tagatose; and more than 0 to 1 part by weight of Lactobacillus rhamnosus.

According to another exemplary embodiment of the present invention, there is provided a concentrated fermented milk composition containing: based on 100 parts by weight of the entire composition,

more than 0 to 20 parts by weight of tagatose;

more than 0 to 1 part by weight of Lactobacillus rhamnosus;

50 to 99 parts by weight of raw milk;

more than 0 to 1 part by weight of pectin; and

more than 0 to 50 parts by weight of purified water.

### Advantageous Effects

The present invention may provide synbiotics containing tagatose as a prebiotic and a specific Lactobacillus sp. lactic acid bacterium specifically using tagatose as a probiotic, such that the specific lactic acid bacterium may be dominantly proliferated in the intestine of a host eating the synbiotics.

### DESCRIPTION OF DRAWINGS

FIG. 1 shows a growth curve of a Lactobacillus casei.

FIG. 2 shows a growth curve of Lactobacillus casei Shirota.

FIG. 3 shows a growth curve of a Lactobacillus casei DN114001.

FIG. 4 shows a growth curve of Lactobacillus casei-01®.

FIG. 5 shows a growth curve of Lactobacillus rhamnosus.

FIG. 6 shows a growth curve of Lactobacillus rhamnosus GG.

FIG. 7 shows a growth curve of Pediococcus Pentosaceus.

FIG. 8 shows a growth curve of Lactobacillus farciminis.

FIG. 9 shows a growth curve of Lactobacillus acidophilus.

### MODE

Hereinafter, the present invention will be described in detail. Since contents that are not described in the present specification may be sufficiently recognized and inferred by those skilled in the art or similar art, description thereof will be omitted.

According to an aspect of the present invention, there is provided a food composition containing tagatose and Lactobacillus sp. lactic acid bacteria.

According to another aspect of the present invention, there is provided a food composition containing tagatose, Lactobacillus sp. lactic acid bacteria, raw milk, pectin, and purified water.

The food composition is not particularly limited and may be utilized as various food or food compositions.

The food composition may be utilized preferably as milk products, for example, fermented milk and/or concentrated fermented milk, or the like.

According to another aspect of the present invention, there is provided a food composition containing, based on 100 parts by weight of the entire composition,

more than 0 to 20 parts by weight of tagatose; and

more than 0 to 1 part by weight of Lactobacillus sp. lactic acid bacteria.

According to another aspect of the present invention, there is provided a concentrated fermented milk composition containing, based on 100 parts by weight of the entire composition,

more than 0 to 20 parts by weight of tagatose;

more than 0 to 1 part by weight of Lactobacillus sp. lactic acid bacteria;

50 to 99 parts by weight, more preferably, 70 to 90 parts by weight of raw milk;

more than 0 to 1 part by weight, more preferably, more than 0 to 0.5 parts by weight of pectin; and

more than 0 to 50 parts by weight, more preferably, 1 to 10 parts by weight of purified water.

The term “raw milk” as used herein, which is used as a term generally recognized in the art, means unprocessed milk produced from cows.

The term “pectin” as used herein, which is used as a term generally recognized in the art, means purified polysaccharide carbohydrates widely distributed in land animals and plants and obtained by aqueous extraction particularly from apples, citrus fruits (lemon, lime, orange, or the like), or the like.

The concentrated fermented milk composition may further contain (mixed) skim milk powder, sugar, fructose, glucose, (concentrated) fruit juice, spice processed product, or the like.

According to another aspect of the present invention, there is provided a fermented milk composition containing,

based on 100 parts by weight of the entire composition,

more than 0 to 20 parts by weight of tagatose;

more than 0 to 1 part by weight of Lactobacillus sp. lactic acid bacteria;

more than 0 to 10 part by weight, more preferably, 3 to 5 parts by weight of skim milk powder; and

more than 50 to 99 parts by weight, more preferably, more than 80 to 95 parts by weight of purified water.

The term “skim milk powder” as used herein, which is used as a term generally recognized in the art, means a resultant obtained by separating and removing a fat component from milk. The skim milk powder used in the present invention may be mixed skim milk powder, wherein the mixed skim milk powder means a product obtained by mixing, for example, grain flour (rice flour, or the like), grain products (wheat flour, or the like), food additives such as cocoa products, whey powder, or the like, with skim milk powder or milk powder in which skim milk powder and cream milk powder are mixed with each other, and processing and powdering the mixture.

The fermented milk composition may further contain glucose, sugar, spice processed products, or the like.

The Lactobacillus sp. lactic acid bacteria used in the present invention may be preferably Lactobacillus casei, Lactobacillus rhamnosus, Lactobacillus farciminis, or lactobacillus acidophilus.

Since these strains have excellent capacity of using tagatose as a source of nutrients in a host as compared to other strains, these strains may be efficiently utilized as a probiotic of the synbiotic composition using tagatose as a prebiotic, such that these strains are balanced in the intestinal microflora of the host and particularly, become dominant in the intestine of the host, thereby having a positive effect on metabolism of the host.

It has been known that among the above-mentioned lactic acid bacteria, particularly, Lactobacillus casei and Lactobacillus rhamnosus, have beneficial effects on the human body such as various functional effects associated with immunity, an anticancer effect, and the like, in addition to intestinal regulation actions, such that Lactobacillus casei and Lactobacillus rhamnosus have been commercialized in various products around the world.

The Lactobacillus casei, which is a known strain belonging to the lactic acid bacteria, may include Lactobacillus casei Shirota, Lactobacillus casei DN114001, and Lactobacillus casei-01® (Reference: Kazumasa Matsumoto et al., ┌Effects of a Probiotic Fermented Milk Beverage Containing Lactobacillus Casei Strain Shirota on Defecation Frequency, Intestinal Microbiota, and the Intestinal Environment of Healthy Individuals with Soft Stools┘, Journal of Bioscience and Bioengineering VOL. 110 No. 5, 547-552, 2010; Chu-Ting Liu et al., ┌Antiproliferative and Anticytotoxic Effects of Cell Fractions and Exopolysaccharides from Lactobacillus Casei 01┘, Mutation Research 721(2011)157-162; Maija Saxelin et al., ┌Probiotic and Other Functional Microbes: from Markets to Mechanisms┘, Current Opinion in Biotechnology 2005, 16:204-211; Antonis Ampatzoglou et al., ┌Influence of Fermentation on the Acid Tolerance and Freeze drying Survival of Lactobacillus Rhamnosus GG┘, Biochemical Engineering Journal, 52(2010) 65-70; or the like).

The Lactobacillus casei used in the present invention may be preferably selected from a group consisting of Lactobacillus casei Shirota, Lactobacillus casei DN114001, and Lactobacillus casei-01®, and one or a combination of two or more thereof may be used.

The Lactobacillus rhamnosus used in the present invention may be preferably Lactobacillus rhamnosus GG.

Hereinafter, the present invention will be described in detail through Examples. However, these Examples are only to illustrate the present invention, and a scope of the present invention is not limited thereto.

### EXAMPLE 1

Selection of Lactic Acid Bacteria Having Excellent Capacity Using Tagatose

The capacity of using tagatose was evaluated on known lactic acid bacteria (250 commercial strains, 25 strains isolated from humans, and 110 lactic acid bacteria strains isolated from milk products on the market)

(1) Isolation of Strain

Pure culture solutions (1% culture solution in a stationary-phase in which a cell count of each of the strains is about 10⁸ to 10⁹ cfu/ml) of a total of 385 lactic acid bacteria strains were inoculated in selective media, respectively, and cultured in an incubator at 37° C. for 18 hours, followed by sub-culturing three times. Then, experiments proceeded at a state in which viability of the strain was optimal.

(2) Preparation of Culture Medium

In order to evaluate the capacity of using tagatose of each of the lactic acid bacteria, a minimal medium composed of 5 g of peptone, 2.5 g of sodium acetate trihydrate, 0.5 ml of magnesium sulfate heptahydrate, 0.5 ml of manganese sulfate tetrahydrate, 5 ml of Tween 80, 1 g of diammonium citrate, 1 g of dipotassium phosphate, and 480 ml of distilled water was used.

After the medium was sterilized at 121° C. for 15 minutes and divided into three samples, 20 ml of 50% tagatose solution, 20 ml of 50% glucose solution, and 20 ml of 50% fructooligosaccharide solution (FOS) were added to each of the three samples, thereby preparing liquid media.

(3) Culturing

1% of each of the lactic acid bacteria strains cultured as described above was inoculated in the prepared medium and cultured in an incubator at 37° C. for 24 hours. Thereafter, absorbance of each of the cultured strains was measured using an ELISA reader, and a cell count was measured through plate culture using a dilution solution, thereby evaluating the capacity of using tagatose.

### EXAMPLE 2

Identification of Excellent Strain According to Results in Example 1

19 strains having excellent capacity of using tagatose were selected from each of the lactic acid bacteria cultured in Example 1 and identified by isolating 16s rDNAs thereof.

2 ml of a culture solution of each of the cultured lactic acid bacteria was extracted (O.D(600): 0.8 to 1.0) and centrifuged at 13,000 rpm for 1 minute, thereby removing a supernatant. Then, 50 ul of a refrigerated pre-buffer (containing 15 ul of RNase A) and 3 ul of a lysozyme solution were suitably mixed with each other and treated, and a cell pellet was treated with this mixture.

The treated cell pellet was turned over every 5 minutes while being left at 37° C. for 15 minutes, thereby performing a reaction. Thereafter, 250 ul of a refrigerated G-buffer (containing 210 ul RNase A and proteinase K solution) was added thereto and completely mixed therewith.

The resultant was turned over every 5 minutes while being left at 65° C. for 15 minutes, thereby performing reaction. Then, 250 ul of a refrigerated binding buffer was added thereto and completely mixed therewith.

Next, after the cell lysate (800 ul or less) was loaded onto a column and centrifuged at 13,000 rpm for 1 minute, 500 ul of a washing buffer A (containing 21 ml of absolute ethanol (EtOH)) was added for washing into the column and centrifuged again at 13,000 rpm for 1 minute.

Thereafter, after removing the solution, a G-spin column was stationed on a new 1.5 ml Eppendorf-tube. Then, 50 to 200 ul of an elution buffer was directly loaded on a membrane, left at room temperature for 1 minute, and then centrifugation was performed, thereby obtaining gDNA.

After extracting DNA from specimens, an interface sequence between 16S rRNA, 23S rRNA, or 16S rRNA and 23S rRNA, which was common in bacteria, was amplified by a polymerase chain reaction (PCR). Then, after performing the fluorescence terminator sequencing, the DNA was isolated in a sequence gel by electrophoresis, and a base sequence in a nucleotide component was determined using an automated sequencer. Next, the base sequence result was input into a computer and compared with a DNA base sequence according to the strain embedded in the computer, thereby identify the strain.

As a result of selecting 19 strains having the most excellent capacity of using tagatose from the total of 385 strains and isolating and identifying the 16s rDNAs thereof as described above, 9 Lactobacillus casei strains, 6 Lactobacillus rhamnosus strains, 2 Pediococcus pentosaceus strains, a single Lactobacillus farciminis strain, and a single Lactobacillus acidophilus strain were confirmed.

The selected 19 strains were shown in the following Table 1. As shown in Table 1, among them, L. casei Shirota, L. casei DN114001, L. casei-01, and L. rhamnosus GG had significantly excellent capacity of using tagatose as compared to the other strains.

TABLE 1

| | | Log₁₀ Value of Live Cell Count | | | | |
|---|---|---|---|---|---|---|
| | | | | 24h | | |
| | | | | Fructo | | |
| | | | 24h | oligo | 24h | Tagatose/ |
| | Strain | 0h | Glucose | saccharide | Tagatose | Glucose |
| 1 | L. casei | 6.648 | 7.855 | 8.349 | 7.882 | 100.3% |
| 2 | L. casei | 7.364 | 8.127 | 8.139 | 8.137 | 100.1% |
| 3 | L. casei | 6.829 | 8.273 | 8.206 | 8.240 | 99.6% |
| 4 | L. casei | 6.941 | 8.512 | 7.518 | 8.424 | 99.0% |
| 5 | L. casei | 7.077 | 9.078 | 7.716 | 8.449 | 93.1% |
| 6 | L. casei | 7.329 | 8.877 | 8.340 | 8.767 | 98.8% |
| 7 | L. casei Shirota | 7.309 | 8.932 | 8.289 | 9.054 | 101.4% |
| 8 | L. casei | 7.273 | 8.803 | 8.268 | 8.953 | 101.7% |
| | DN114001 | | | | | |
| 9 | L. casei-01® | 7.448 | 8.940 | 8.228 | 9.068 | 101.4% |
| 10 | L. rhamnosus | 6.835 | 8.057 | 7.518 | 7.939 | 98.5% |
| 11 | L. rhamnosus | 6.875 | 8.096 | 7.475 | 8.031 | 99.2% |
| 12 | L. rhamnosus | 6.975 | 8.179 | 7.556 | 8.059 | 98.5% |
| 13 | L. rhamnosus | 6.812 | 8.206 | 7.322 | 8.169 | 99.5% |
| 14 | L. rhamnosus GG | 6.938 | 8.144 | 7.439 | 8.548 | 105.0% |
| 15 | L. rhamnosus GG | 7.242 | 8.520 | 8.779 | 8.822 | 103.5% |
| 16 | P. pentosaceus | 7.275 | 8.877 | 8.082 | 8.798 | 99.1% |
| 17 | P. pentosaceus | 7.579 | 9.062 | 8.087 | 8.953 | 98.8% |
| 18 | L. farciminis | 7.140 | 8.666 | 8.402 | 8.601 | 99.2% |
| 19 | L. acidophilus | 7.028 | 8.045 | 7.160 | 7.913 | 98.4% |

### EXAMPLE 3

Capacity of Using Other Prebiotics in Some of Lactic Acid Bacteria Identified in Example 2

Capacity of using other prebiotics except for tagatose was evaluated, compared and analyzed using 9 strains having excellent capacity of using tagatose among the 19 strains identified in Example 2.

For the present evaluation, at the time of preparing the medium used in Example 1, as a positive control group, glucose was used except for tagatose, and as negative control groups, fructooligosaccharide, lactitol, lactulose, and xylitol were used.

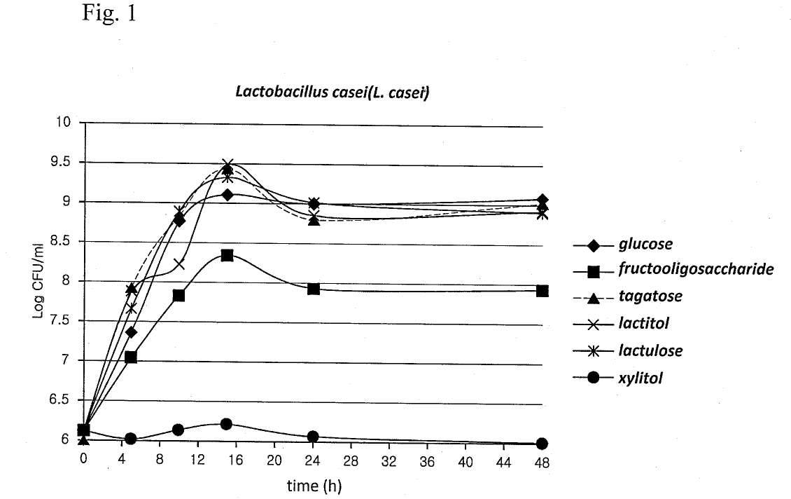

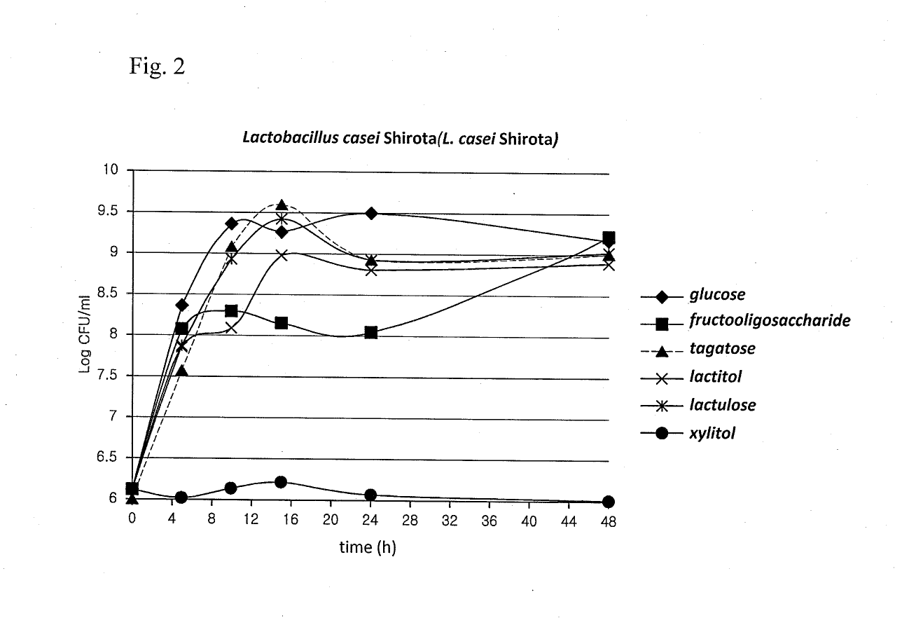

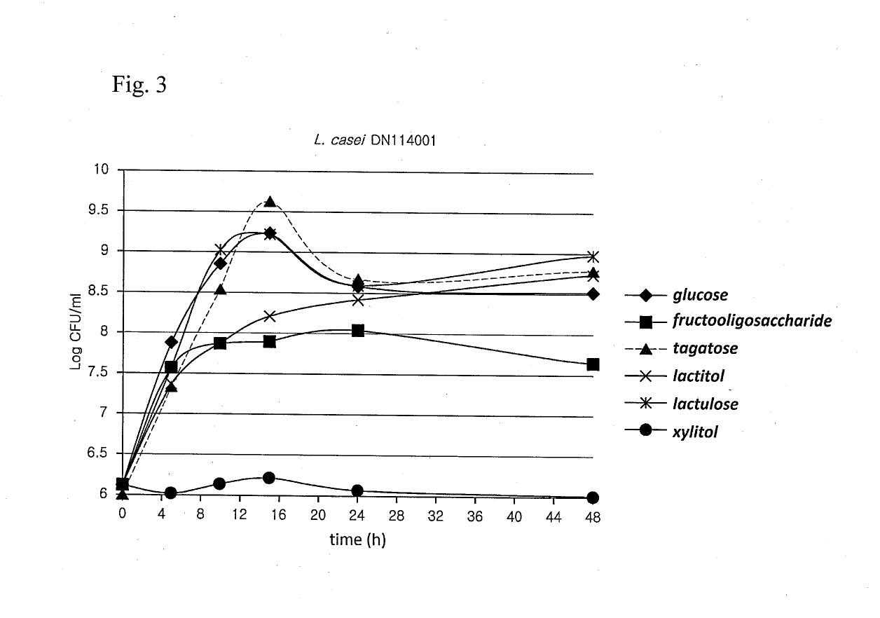

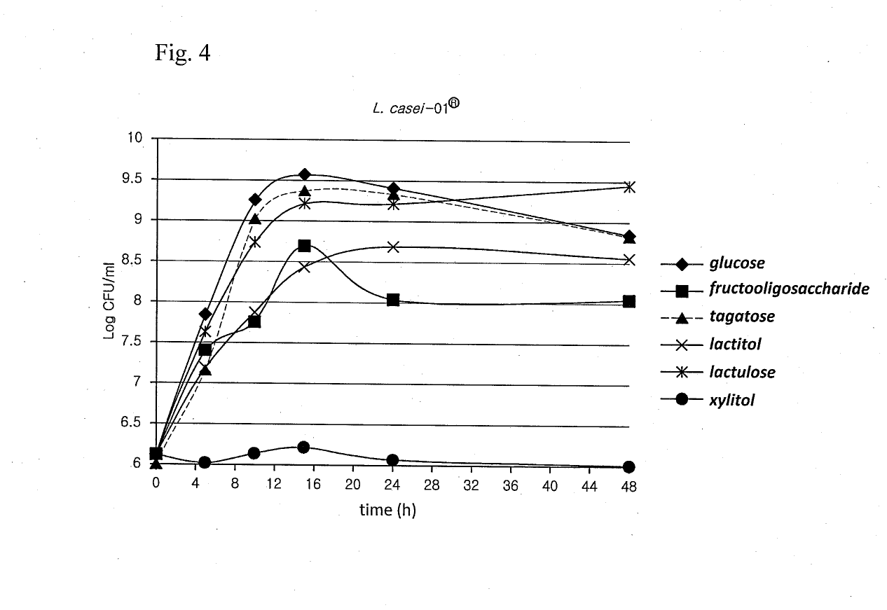

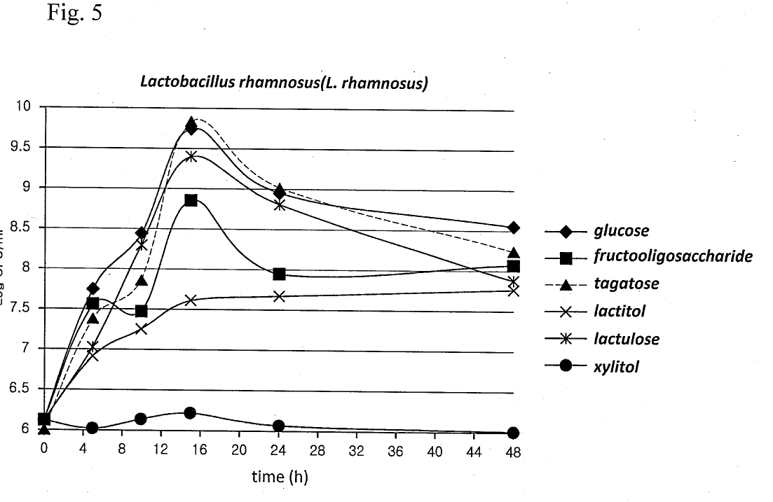

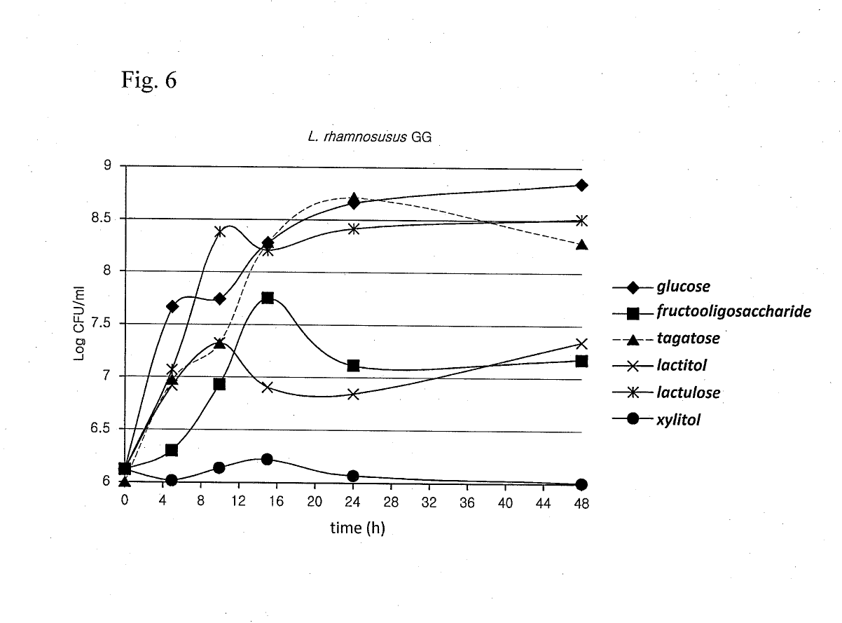

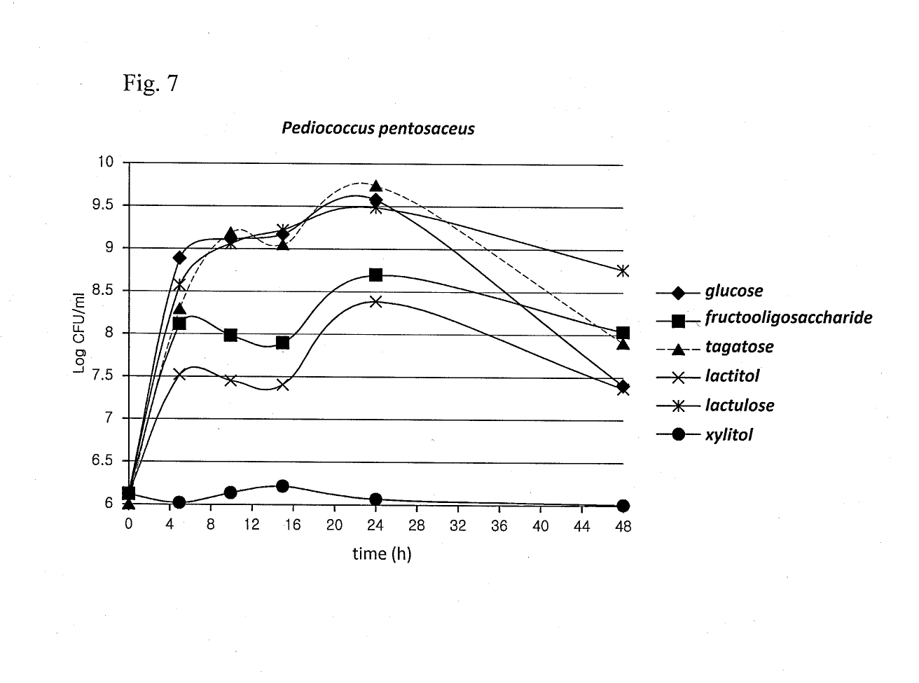

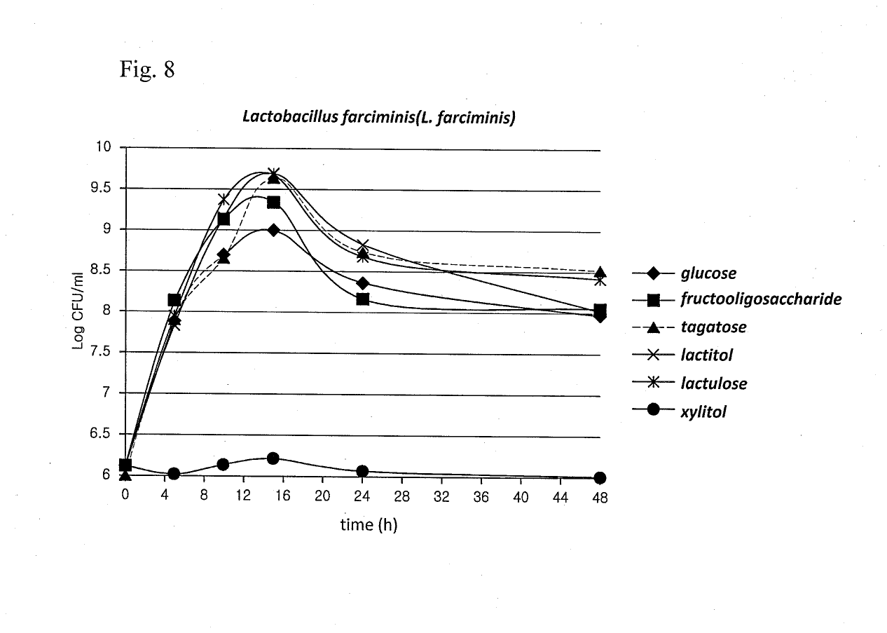

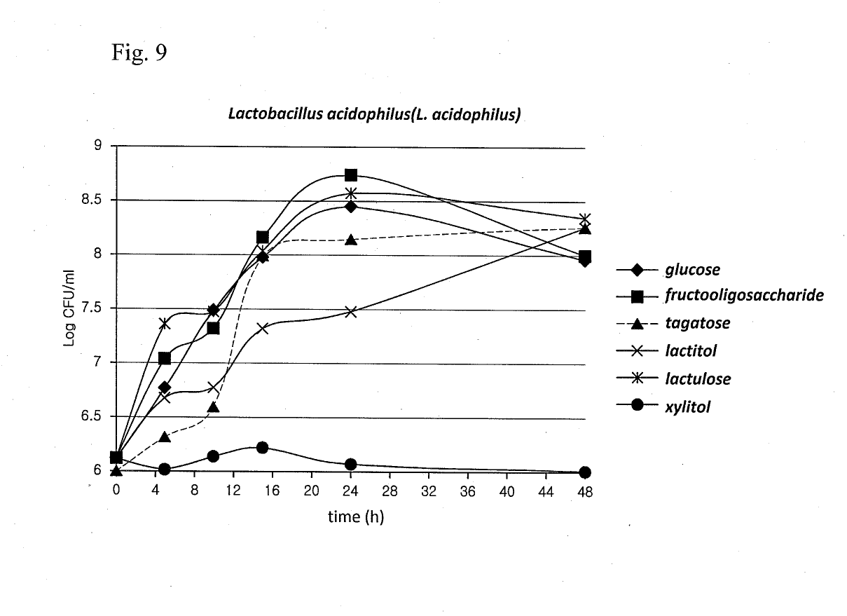

Each of the Lactobacillus casei (FIG. 1), Lactobacillus casei Shirota (FIG. 2), Lactobacillus casei DN114001 (FIG. 3), Lactobacillus casei-01® (FIG. 4), Lactobacillus rhamnosus (FIG. 5), Lactobacillus rhamnosus GG (FIG. 6), Pediococcus pentosaceus (FIG. 7), Lactobacillus farciminis (FIG. 8), and Lactobacillus acidophilus (FIG. 9) that were identified in Example 2 was inoculated in each of the media and cultured at 37° C. for 0, 5, 10, 24, and 48 hours. Then, a live cell count thereof was measured, such that a growth curve of each of the strains was obtained.

As a result of comparing the growth curves of the lactic acid bacteria strains efficiently using tagatose, capacity of using glucose, tagatose, and lactulose was similar to each other, but capacity of using fructooligosaccharide and lactitol was low.

### EXAMPLE 4

Preparation of Synbiotic Concentrated Fermented Milk Composition Containing Tagatose and Lactobacillus rhamnosus (Lactic Acid Bacterium)

In order to prepare a synbiotic concentrated fermented milk (curd fermented milk, drink fermented milk, or the like) composition containing tagatose as a prebiotic and a Lactobacillus rhamnosus GG strain as a probiotic, the following method was performed, thereby preparing concentrated fermented milk having a constitution shown in the following Table 2.

First, raw milk and (mixed) skim milk powder were mixed at a mixing ratio, homogenized at a pressure of 150 bar, and passed through a heat exchanger to thereby be sterilized. Then, a temperature was lowered to 40° C., and the Lactobacillus rhamnosus GG strain obtained in Example 2 and Streptococcus thermophilus were inoculated therein. Next, after fermentation for 6 hours, when a pH became 4.6, curd was cooled while being crushed. At this time, in the case of drink type concentrated fermented milk, homogenization was performed again at a pressure of 150 bar, thereby preparing a culture solution.

Meanwhile, separately, tagatose, white sugar (white sugar may be replaced by fructose or glucose), concentrated strawberry juice or strawberry flesh, pectin, strawberry flavor, and purified water were mixed, sterilized, and cooled, thereby preparing syrup or jam.

The prepared culture solution and syrup or jam were mixed at a predetermined ratio, and then, refrigerated at 10° C. or less.

TABLE 2

| | Sam- | Sam- | Sam- | Sam- | Sam- |
|---|---|---|---|---|---|
| Raw Material | ple 1 | ple 2 | ple 3 | ple 4 | ple 5 |
| Raw Milk | 77.0 | 77.0 | 77.0 | 77.0 | 77.0 |
| (Mixed) Skim | 3.0 | 3.0 | 3.0 | 3.0 | 3.0 |
| Milk Powder | | | | | |
| Tagatose | 2.0 | 4.0 | 6.0 | 8.0 | 10.0 |
| White Sugar | 7.2 | 5.4 | 3.6 | 1.8 | 0.0 |
| Concentrated | 6.0 | 6.0 | 6.0 | 6.0 | 6.0 |
| Fruit Juice or | | | | | |
| Fruit Flesh | | | | | |
| Pectin | 0.1 | 0.1 | 0.1 | 0.1 | 0.1 |
| Flavor | 0.02 | 0.02 | 0.02 | 0.02 | 0.02 |
| L. rhamnosus | 0.01 | 0.01 | 0.01 | 0.01 | 0.01 |
| GG | | | | | |
| Streptococcus | 0.01 | 0.01 | 0.01 | 0.01 | 0.01 |
| thermophilus | | | | | |
| Purified Water | 4.66 | 4.46 | 4.26 | 4.06 | 3.86 |

### EXAMPLE 5

Preparation of Synbiotic Fermented Milk Composition Containing Tagatose and Lactobacillus casei (Lactic Acid Bacterium)

In order to prepare a synbiotic fermented milk (liquid fermented milk, or the like) composition containing tagatose as a prebiotic and a Lactobacillus casei-01® strain as a probiotic, the following method was performed, thereby preparing concentrated fermented milk having a constitution shown in the following Table 5.

First, after (mixed) skim milk powder, glucose hydrocrystalline, and purified water were mixed with each other, sterilized at 105° C. for 90 minutes, and cooled to 40° C., the Lactobacillus casei-01® obtained in Example 2 was inoculated therein. Thereafter, the resultant was fermented for 5 days, and when a pH became 3.6, a temperature was lowered, thereby preparing a culture solution. A constitution of the culture solution was shown in the following Table 3.

Meanwhile, separately, tagatose, white sugar (white sugar may be replaced by fructose), and purified water were mixed, sterilized, and cooled, thereby preparing a syrup. A constitution of the syrup was shown in the following Table 4.

After mixing the prepared culture solution and syrup at a ratio of 1:1, a small amount of yogurt flavor was added while mixing the mixture with purified water again at a ratio of 1:1. Then, the resultant was refrigerated at 10° C. or less.

A constitution of the finally prepared fermented milk composition was shown in the following Table 5.

TABLE 3

| | Sam- | Sam- | Sam- | Sam- | Sam- |
|---|---|---|---|---|---|
| Raw Material | ple 1 | ple 2 | ple 3 | ple 4 | ple 5 |
| (Mixed) Skim | 14.0 | 14.0 | 14.0 | 14.0 | 14.0 |
| Milk Powder | | | | | |
| Glucose | 2.0 | 2.0 | 2.0 | 2.0 | 2.0 |
| Hydrocrystalline | | | | | |
| L. casei-01 ® | 0.02 | 0.02 | 0.02 | 0.02 | 0.02 |
| Purified Water | 83.8 | 83.8 | 83.8 | 83.8 | 83.8 |

TABLE 4

| | Sam- | Sam- | Sam- | Sam- | Sam- |
|---|---|---|---|---|---|
| Raw Material | ple 1 | ple 2 | ple 3 | ple 4 | ple 5 |
| Tagatose | 4.0 | 8.0 | 12.0 | 16.0 | 20.0 |
| White Sugar | 14.4 | 10.8 | 7.2 | 3.6 | 0.0 |
| Purified Water | 81.6 | 81.2 | 80.8 | 80.4 | 80.0 |

TABLE 5

| | Sam- | Sam- | Sam- | Sam- | Sam- |
|---|---|---|---|---|---|
| Raw Material | ple 1 | ple 2 | ple 3 | ple 4 | ple 5 |
| (Mixed) Skim | 3.5 | 3.5 | 3.5 | 3.5 | 3.5 |
| Milk Powder | | | | | |
| Crystalline Glucose | 0.5 | 0.5 | 0.5 | 0.5 | 0.5 |
| Monohydrate | | | | | |
| L. casei-01 ® | 0.005 | 0.005 | 0.005 | 0.005 | 0.005 |
| Tagatose | 1.0 | 2.0 | 3.0 | 4.0 | 5.0 |
| White Sugar | 3.6 | 2.7 | 1.8 | 0.9 | 0.0 |
| Flavor | 0.05 | 0.05 | 0.05 | 0.05 | 0.05 |
| Purified Water | 91.345 | 91.245 | 91.145 | 91.045 | 90.945 |

1. A food composition comprising tagatose and Lactobacillus casei.

2. The food composition of claim 1, wherein the Lactobacillus casei is one or more selected from a group consisting of Lactobacillus casei Shirota, Lactobacillus casei DN114001, and Lactobacillus casei-01®.

3. The food composition of claim 1, wherein based on 100 parts by weight of the composition, it contains more than 0 to 20 parts by weight of tagatose; and more than 0 to 1 part by weight of Lactobacillus casei.

4. The food composition of claim 1, wherein the food composition containing:
based on 100 parts by weight of the entire composition,
more than 0 to 20 parts by weight of tagatose;
more than 0 to 1 part by weight of Lactobacillus casei;
more than 0 to 10 parts by weight of skim milk powder; and
50 to 99 parts by weight of purified water.

5. A food composition comprising tagatose and Lactobacillus rhamnosus.

6. The food composition of claim 5, wherein the Lactobacillus rhamnosus is Lactobacillus rhamnosus GG.

7. The food composition of claim 5, wherein based on 100 parts by weight of the composition, it contains more than 0 to 20 parts by weight of tagatose; and more than 0 to 1 part by weight of Lactobacillus rhamnosus.

8. The food composition of claim 5, wherein the food composition containing:
based on 100 parts by weight of the entire composition,
more than 0 to 20 parts by weight of tagatose;
more than 0 to 1 part by weight of Lactobacillus rhamnosus;
50 to 99 parts by weight of raw milk;
more than 0 to 1 part by weight of pectin; and
more than 0 to 50 parts by weight of purified water.
